(19) United States
(12) Patent Application Publication
(10) Pub. No.: US 2009/0003470 A1
(43) Pub. Date: Jan. 1, 2009

(54) OFDM OOB emission suppression at specific frequencies

(76) Inventor: Alan E. Waltho, San Jose, CA (US)

Correspondence Address: RYDER IP LAW;C/O INTELLEVATE, LLC, P. O. BOX 52050, MINNEAPOLIS, MN, 55402, US

(21) Appl. No.: 11/824,236

(22) Filed: Jun. 29, 2007

(51) Int. Cl. H04B 15/00; H04J 11/00

(52) U.S. Cl. 375/260

(57) ABSTRACT

In general, in one aspect, the disclosure describes an apparatus that includes a radio to provide wireless communications using Orthogonal Frequency Division Multiplexing (OFDM) signaling. A controller is used to determine location of un-modulated carriers in order to suppress out of band (OOB) emissions at a particular frequency.

### BACKGROUND

In North America digital television broadcasting is guided by the Advanced Television Systems Committee (ATSC) A/53 standard (ATSC standard). The ATSC standard uses 8-level Trellis coded Vestigial SideBand (8-VSB) modulation to transmit the digital broadcasts within 6 MHz bandwidth channels. The signal level (power) is flat throughout most of the channel but includes two steep transition regions (each 620 kHz wide) at each end of the channel. The lower channel edge includes a suppressed carrier (ATSC pilot carrier) that is utilized for frequency and phase lock which is required for subsequent demodulation of the amplitude and phase modulated data signals. Due to the low level of the pilot carrier the ATSC signal is vulnerable to interference that occurs at or close to the pilot carrier frequency.

The federal communications commission (FCC) has proposed allowing unlicensed devices (such as wireless local area networks (WLAN) and wireless personal area networks (WPAN)) to operate in the frequency between broadcast channels (so called TV white space). The close proximity in frequency of the TV white space to the pilot carrier for a next broadcast channel makes the pilot carrier vulnerable to interference from unlicensed communications devices within the TV white space. This interference vulnerability may limit the power and hence range of unlicensed devices if they are to avoid causing interference to TV receivers.

### BRIEF DESCRIPTION OF THE DRAWINGS

The features and advantages of the various embodiments will become apparent from the following detailed description in which:

FIG. 1 illustrates an example of an Orthogonal Frequency Division Multiplexing (OFDM) signal having particular sub-carriers un-modulated so as to suppress out of band (OOB) emissions from occurring at a particular frequency (ATSC pilot carrier), according to one embodiment; and

FIG. 2 illustrates a graph of the relationship between the number of un-modulated sub-carriers for an example OFDM signal and the relative level of OOB at a particular frequency (ATSC pilot carrier), according to one embodiment.

### DETAILED DESCRIPTION

Many wireless networks communicate using Orthogonal Frequency Division Multiplexing (OFDM) signaling. An OFDM signal is comprised of multiple sub-carriers each modulated at a symbol rate equal to the reciprocal of the frequency separation. The resultant spectrum is essentially flat over the entire bandwidth of the signal. Some OFDM sub carriers are used as pilot tones to facilitate synchronization and equalization of the OFDM signal and accordingly are un-modulated.

Intermodulation products generated within an OFDM power amplifier create out of band (OOB) emissions in adjacent channels. The OOB emissions due to modulated sub-carriers are a continuous spectrum across the adjacent channel. If the adjacent channel is a digital TV channel, the OOB emissions at the frequency of the ATSC pilot carrier may cause interference with the ATSC pilot carrier. The sub-carriers used for pilot tones may be selected so the OOB emissions are minimized at specific frequencies. For example, the sub-carriers selected for use as pilot tones may suppress the OOB emissions from occurring at the frequency of the ATSC pilot carrier in the adjacent channel.

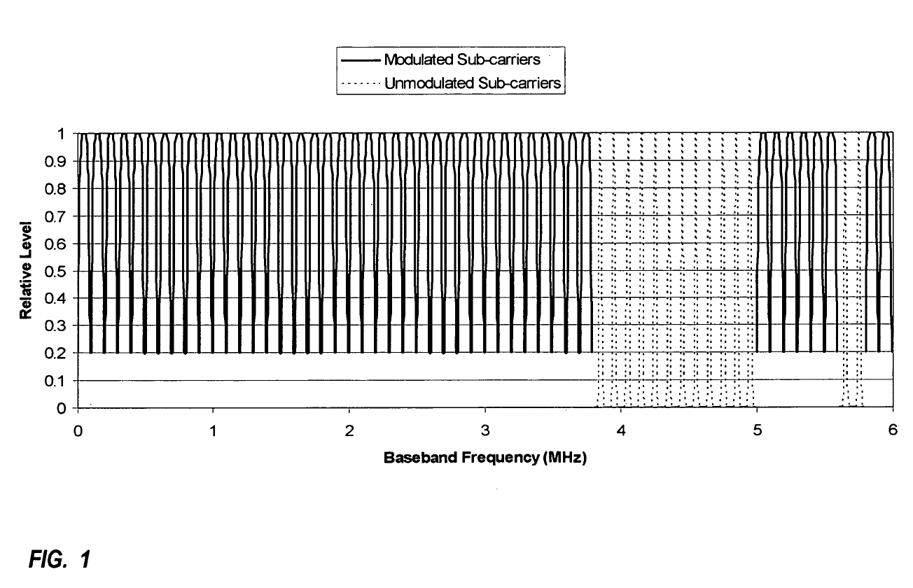

FIG. 1 illustrates an example of an OFDM signal having particular sub-carriers un-modulated in order to suppress intermodulation products from occurring at the frequency of the ATSC pilot carrier in the adjacent channel. The example OFDM signal is a 50 tone signal with 15 sub-carriers un-modulated (those between approximately 3.1 and 4.8 MHz and approximately 5.5 and 5.7 MHz). The un-modulated sub-carriers are not limited to those illustrated in the example OFDM signal. For other size OFDM sub-carrier sets other sub-sets of sub-carriers may be un-modulated in order to suppress the OOB emissions from occurring at the frequency of the ATSC pilot carrier.

The degree of suppression is dependent on the number of un-modulated sub-carriers. Increasing the number of un-modulated sub-carriers increases the suppression. Depending on the suppression required, the number of sub-carriers that are un-modulated may exceed the number of sub-carriers required for pilot tones by the OFDM signal. Increasing the number of un-modulated sub-carriers may decrease the data rate of the OFDM signal. The intermodulation due to the un-modulated carriers may cause a narrow band spike. The sub-carrier spacing can be selected so that the spectral spike of the sub-carrier intermodulation does not occur at the frequency of the ATSC pilot carrier.

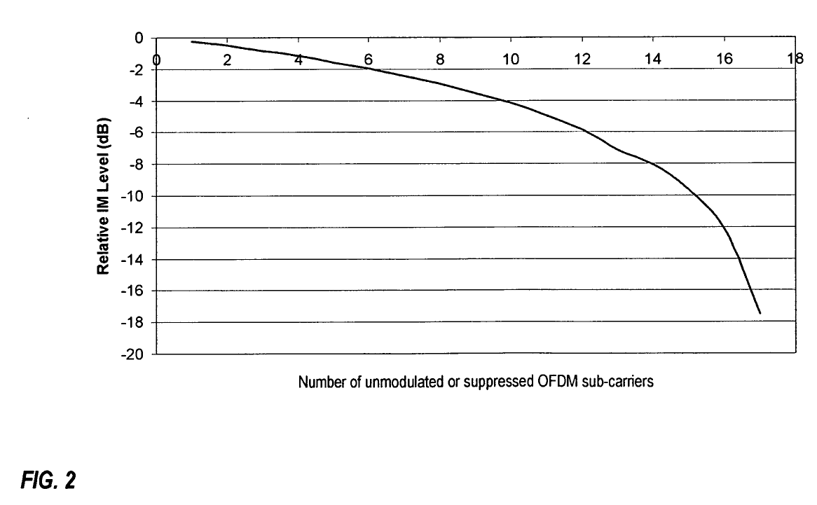

FIG. 2 illustrates a graph of the relationship between the number of un-modulated sub-carriers for an example OFDM signal and the relative level of intermodulation at the ATSC pilot carrier frequency. The example OFDM signal is a 50 tone signal with the un-modulated sub-carriers being in the frequency range to suppress the OOB emissions from occurring at the frequency of the ATSC pilot carrier. The graph illustrates that the more carriers that are un-modulated the less the relative intermodulation level is at the ATSC pilot carrier frequency.

If the number un-modulated sub-carriers exceeds the number required for efficient reception of the OFDM signal (e.g., the number required for pilot tones), the excess sub-carriers, or a sub-set of them, may be entirely suppressed instead.

The suppression of OOB emissions at the frequency of the ATSC pilot carrier increases a protection margin for the prevention of interference to ATSC TV receivers. This protection margin can be used to allow operation of OFDM communications devices (e.g., portable devices, base stations) in closer proximity to a TV receiver, or at higher power to increase the range. As data rate increases in importance as compared to proximity and/or range, the number of un-modulated carriers may be reduced and the suppression and protection margin are accordingly reduced. A controller within the OFDM communication device may determine the number and location of sub-carriers that are un-modulated or suppressed.

The OFDM un-modulated sub-carrier selection was defined with specific reference to limiting interference to the ATSC pilot carrier but is in no way limited thereto. Rather, the selection of un-modulated OFDM sub-carriers could be used to minimize interference between other wireless devices with increased vulnerability to interference at specific frequencies (e.g., WMAN, WLAN, WPAN).

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. An apparatus comprising
a radio to provide wireless communications using Orthogonal Frequency Division Multiplexing (OFDM) signaling; and
a controller to determine location of un-modulated sub-carriers in order to suppress out of band (OOB) emissions at a particular frequency.

2. The apparatus of claim 1, wherein the OOB emissions include intermodulation products of the OFDM signal.

3. The apparatus of claim 1, wherein at least a subset of the un-modulated sub-carriers include pilot tones.

4. The apparatus of claim 1, wherein the controller is to select sub-carrier spacing to avoid spectral spike created from the un-modulated sub-carriers from occurring at the particular frequency.

5. The apparatus of claim 1, wherein the controller is to select number of un-modulated sub-carriers to control level of suppression at the particular frequency.

6. The apparatus of claim 5, wherein the controller is to suppress certain sub-carriers if level of suppression at the particular frequency requires more un-modulated sub-carriers than are required for pilot signals.

7. The apparatus of claim 5, wherein the controller is to control level of suppression based on proximity to device operating at the particular frequency level.

8. The apparatus of claim 5, wherein the controller is to control level of suppression based on desired signal strength.

9. The apparatus of claim 5, wherein the controller is to control level of suppression based on desired data rate.

10. The apparatus of claim 1, wherein the particular frequency is a frequency associated with Advanced Television Systems Committee (ATSC) pilot carrier.

11. The apparatus of claim 1, wherein the particular frequency is a frequency to which a victim receiver exhibits excessive vulnerability to interference.

12. The apparatus of claim 1, wherein the apparatus is an unlicensed device operating in frequency between broadcast channels.

13. A method comprising
determining a particular frequency to avoid generating OOB emissions at;
determining location of un-modulated sub-carriers in OFDM frames to suppress the OOB emissions at the particular frequency; and
transmitting the OFDM frames.

14. The method of claim 13, further comprising determining level of suppression based on at least some subset of signal strength, proximity to device operating at the particular frequency and data rate, and selecting number of un-modulated sub-carriers based on level of suppression.

15. The method of claim 14, further comprising selecting certain sub-carriers to be suppressed when number of sub-carriers required for the level of suppression is greater than number required to carry OFDM pilot signals.
